(19) United States
(12) Patent Application Publication
(10) Pub. No.: US 2009/0030603 A1
(43) Pub. Date: Jan. 29, 2009

(54) DIGITAL MAP DATABASE AND METHOD FOR OBTAINING EVACUATION ROUTE INFORMATION

(76) Inventors: William A. Madalin, JR., Bloomfield Hills, MI (US); Jennifer Wills, Macomb, MI (US); Mary Ann Adams, Plymouth, MI (US); Bradley O. Williams, Oxford, MI (US); Reni C. George, Troy, MI (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/829,340

(22) Filed: Jul. 27, 2007

(51) Int. Cl. G01C 21/00

(52) U.S. Cl. 701/202

(57) ABSTRACT

A digital map database includes a road segment data record containing information associated with a particular road segment; and at least one evacuation route attribute associated with the road segment. The evacuation route attribute(s) is/are stored in the road segment data record. Methods for obtaining evacuation route information are also disclosed herein.

### TECHNICAL FIELD

The present disclosure relates generally to digital map databases and to methods for obtaining evacuation route information.

### BACKGROUND

Several states, counties, and cities have identified evacuation routes for vehicles in the event of an emergency, such as, for example, a natural or human-caused disaster. Current methods of informing people of such emergency evacuation routes include road signs, radio media, television media, and/or printed media.

Many people (particularly travelers and those unfamiliar with an area's roads, evacuation routes, and shelters) often encounter difficulty in discovering and following emergency evacuation directions. Additionally, standard evacuation routes that are prepared prior to the onset of an emergency generally do not take into account the specific features and/or nature of the particular incident.

### SUMMARY

A digital map database is disclosed herein. The database includes a road segment data record containing information associated with a particular road segment, and at least one evacuation route attribute associated with the road segment. The evacuation route attribute(s) is/are stored in the road segment data record.

A method for obtaining evacuation route information is also disclosed herein. The method includes extracting at least one road segment having an evacuation route attribute associated therewith from a digital map database, and generating an overlay of the at least one road segment on a map of a predetermined region including the at least one road segment.

### BRIEF DESCRIPTION OF THE DRAWINGS

Features and advantages of the present disclosure will become apparent by reference to the following detailed description and drawings, in which like reference numerals correspond to similar, through not necessarily identical, components. For the sake of brevity, reference numerals or features having a previously described function may not necessarily be described in connection with other drawings in which they appear.

FIG. 1 is a schematic diagram depicting an example of a system for obtaining evacuation route information;

FIG. 2 is a flow diagram depicting an example of the method for obtaining evacuation route information; and

FIG. 3 is a semi-schematic view of an overlay illustrating an evacuation route.

### DETAILED DESCRIPTION

Example(s) of the system and method disclosed herein advantageously provide for improved acquisition of evacuation routes, and improved transmission of such evacuation routes to a vehicle and/or vehicle user in an emergency area. A digital map database including emergency route attribute associated with road segments may be utilized in conjunction with vehicle position data to determine an evacuation route.

It is to be understood that, as defined herein, a user may include vehicle operators, passengers and/or call center service advisors.

It is to be further understood that the type of emergency may include any of a multitude of natural or unnatural (e.g., human- or animal-caused) emergency situations. As non-limitative examples, the emergency may include a hurricane, a tornado, a monsoon, a typhoon, a cyclone, a tsunami, a tidal wave, a volcanic eruption, a landslide, an avalanche, a flood, an earthquake, a fire, an explosion, riots, incidents relating to war and/or terrorism, or combinations thereof.

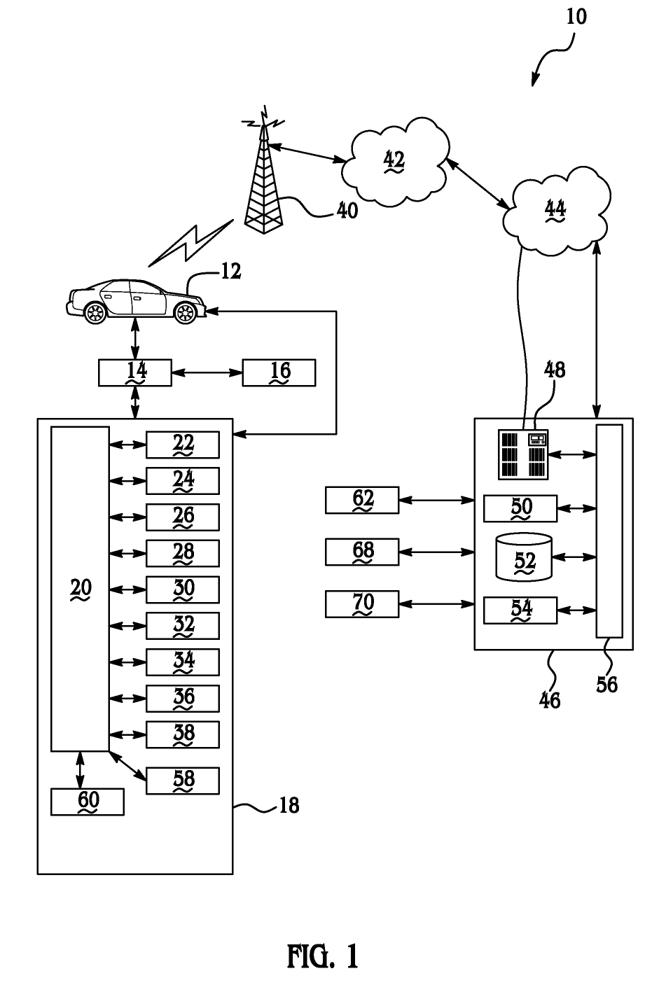

Referring now to FIG. 1, the system 10 includes a vehicle 12, a vehicle communications network 14, a telematics unit 18, a wireless communication system (including, but not limited to, one or more wireless carrier systems 40, one or more communication networks 42, and/or one or more land networks 44). In an example, the wireless communication system is a two-way radio frequency communication system. In another example, the wireless communication system also includes one or more call centers/service providers 46.

Generally, the vehicle 12 is a mobile vehicle with suitable hardware and software for transmitting and receiving voice and data communications. System 10 may include additional components suitable for use in telematics units 18.

In an embodiment, via vehicle communications network 14, the vehicle 12 sends signals from the telematics unit 18 to various units of equipment and systems 16 within the vehicle 12 to perform various functions, such as unlocking a door, executing personal comfort settings, and/or the like. In facilitating interaction among the various communications and electronic modules, vehicle communications network 14 utilizes interfaces such as controller area network (CAN), ISO standard 11989 for high speed applications, ISO standard 11519 for lower speed applications, and Society of Automotive Engineers (SAE) standard J1850 for high speed and lower speed applications.

The telematics unit 18 may send and receive radio transmissions from wireless carrier system 40. In an example, wireless carrier system 40 may be a cellular telephone system and/or any other suitable system for transmitting signals between the vehicle 12 and communications network 42. Further, the wireless carrier system 40 may include a cellular communication transceiver, a satellite communications receiver, a wireless computer network transceiver (a non-limiting example of which includes a Wide Area Network (WAN) transceiver), and/or combinations thereof.

Telematics unit 18 may include a processor 20 operatively coupled to a wireless modem 22, a location detection system 24 (a non-limiting example of which is a global positioning system (GPS)), an in-vehicle memory 26, a microphone 28, one or more speakers 30, an embedded or in-vehicle mobile phone 32, a real-time clock (RTC) 34, a short-range wireless communication network 36 (e.g. a Bluetooth® unit), a user interface 38, and/or a user interface panel 58.

It is to be understood that the telematics unit 18 may be implemented without one or more of the above listed components, such as, for example, speakers 30. Yet further, it is to be understood that the speaker(s) 30 may be a component of the vehicle audio system (which includes a receiver), which may, in addition to radio broadcasts, accept audio and other signals from the telematics unit 18. Telematics unit 18 may also include additional components and functionality as desired for a particular end use.

As an example, a user may communicate with the telematics unit 18 and/or with any equipment and system in operative communication therewith via the user interface panel 58. The user interface panel 58 is equipped with at least one input device such as, for example, a microphone, a button, a keyboard, a knob, a switch, and/or the like.

Processor 20 may be a micro controller, a controller, a microprocessor, a host processor, and/or a vehicle communications processor. In another example, processor 20 may be an application specific integrated circuit (ASIC). Alternatively, processor 20 may be a processor working in conjunction with a central processing unit (CPU) performing the function of a general-purpose processor.

Non-limitative examples of the location detection system 24 include a global position satellite receiver, a radio triangulation system, a dead reckoning position system, and/or combinations thereof. In particular, a GPS provides accurate time and latitude and longitude coordinates of the vehicle 12 responsive to a GPS broadcast signal received from a GPS satellite constellation (not shown).

In-vehicle mobile phone 32 may be a cellular type phone, such as, for example an analog, digital, dual-mode, dual-band, multi-mode and/or multi-band cellular phone.

Also associated with processor 20 is the previously mentioned real time clock (RTC) 34, which provides accurate date and time information to the telematics unit hardware and software components that may require date and time information. In one example, date and time information may be requested from the RTC 34 by other telematics unit components. In other examples, the RTC 34 may provide date and time information periodically, such as, for example, every ten milliseconds.

Processor 20 may execute various computer programs that interact with operational modes of electronic and mechanical systems within the vehicle 12. It is to be understood that processor 20 controls communication (e.g. signals such as call signals) between telematics unit 18, wireless carrier system 40, and call center 46.

Further, processor 20 may generate and accept digital signals transmitted between the telematics unit 18 and the vehicle communication network 14, which is connected to various electronic modules in the vehicle 12. In one example, these digital signals activate the programming mode and operation modes within the electronic modules, as well as provide for data transfer between the electronic modules. In another example, certain signals from processor 20 may be translated into vibrations and/or visual alarms.

It is to be understood that software 60 may be associated with processor 20 for monitoring and/or recording the incoming caller utterances.

The communications network 42 may include services from one or more mobile telephone switching offices and/or wireless networks. Communications network 42 connects wireless carrier system 40 to land network 44. Communications network 42 may be any suitable system or collection of systems for connecting the wireless carrier system 40 to the vehicle 12 and the land network 44.

The land network 44 connects the communications network 40 to the call center 46. In one example, land network 44 is a public switched telephone network (PSTN). In another example, land network 44 is an Internet Protocol (IP) network. In still other examples, land network 44 is a wired network, an optical network, a fiber network, another wireless network, and/or any combinations thereof. The land network 44 may be connected to one or more landline telephones. It is to be understood that the communications network 42 and the land network 44 connect the wireless carrier system 40 to the call center 46.

Call center 46 may contain one or more data switches 48, one or more communication services managers 50, one or more communication services databases 52 containing subscriber profile records and/or subscriber information, one or more communication services advisors 54 and one or more network systems 56.

It is to be understood that, although a service provider may be located at the call center 46, the call center 46 is a separate and distinct entity from the service provider. In an embodiment, the service provider is located remote from the call center 46. A service provider provides the user with telephone and/or Internet services. In an embodiment, the service provider is a wireless carrier (such as, for example, Verizon Wireless®, Cingular®, Sprint®, etc.). It is to be understood that the service provider may interact with the call center 46 to provide service(s) to the user.

Switch 48 of call center 46 may transmit voice or data transmissions from call center 46, and may receive voice or data transmissions from telematics unit 18 in vehicle 12 through wireless carrier system 40, communications network 42, and land network 44. As such, a connection between the telematics unit 18 and the call center 46 may be established via the wireless carrier system 40, communications network 42 and/or land network 44. Switch 48 may receive data transmissions from, or send data transmissions to, one or more communication service managers 50 via one or more network systems 56.

Call center 46 may contain one or more service advisors 54. In one embodiment, a service advisor 54 is human. In another embodiment, a service advisor 54 is an automaton. It is to be understood that the service advisor 54 may be located at the call center 46 or may be located remote from the call center 46 while communicating therethrough.

Communication may be accomplished via voice mode or data mode. Voice mode communications generally occur between the user and the service advisor 54 or some other third party. Data mode communications generally occur between the telematics unit 18 and components of the call center 46 or service provider. In an embodiment, the communication is established via a connection extending (e.g., via the wireless communication system) between the telematics unit 18 and the call center 46.

In the embodiments disclosed herein, verbal communication (voice mode) may take place via microphone 28 coupled to the in-vehicle or mobile phone 32 associated with the telematics unit 18. In an embodiment, caller utterances into the microphone 28 are received at the call center 46, which may tokenize the utterance stream for further processing. In another embodiment, the tokenized utterances are placed in a subscriber information database 52 at the call center 46.

Communication between the telematics unit 18 user and a service advisor 54 (or between a telematics unit 18 and components of the call center 46) may be initiated automatically, or may be initiated by the user or the service advisor 54. In an embodiment, the user may initiate a call or a request, such as, for example, for telephone communication or a navigation communication, via an input system in communication with the telematics unit 18 and/or the two-way radio frequency communication system. Initiation of the communication may be verbal and/or via a physical motion. As such, the input system may include an alphanumeric keypad, a microphone 28, a menu selection system, and/or combinations thereof.

The call center 46 also includes a digital map database 62. It is to be understood that the digital map database 62 may be located at the call center 46, or may be located remote from the call center 46 in a manner such that it is accessible to the service advisors 54.

The digital map database 62 includes road segment data records, each of which contains information (i.e., data attributes) associated with a particular road segment. Non-limiting examples of such information include the type of road (freeway, secondary, tertiary, etc.), the direction of the road (one way, two way), the number of lanes, shape points describing the road geometry (e.g., points along the road, typically latitude and longitude values that are used to generate the overall shape of the segment), the speed along the segment, intersection information, and/or the like, and/or combinations thereof.

The road segment data records may also store one or more evacuation route attributes that are associated with the particular road segment. Non-limiting examples of such attributes are those that identify the road segment as part of an evacuation route, identify traffic flow, direction (e.g., reversal from the normal direction) or volume of the road segment when used as an evacuation route, identify the status of road segment intersections, identify the status of road segment entrances and/or exits, and/or the like, and/or combinations thereof. It is to be understood that the evacuation route attributes saved in the database 62 may be general evacuation route information, or they may be specific to the type of emergency. The evacuation route attributes may be updated or altered as frequently as is desirable. As one example, if a particular road segment is under construction, the evacuation route attribute for this road segment may be temporarily flagged as being a less desirable route, or as being unavailable as an evacuation route or a normally explicated route for the period during which the construction is taking place. This attribute may be removed when the construction has been completed. As another example, if a particular road segment is underwater and un-traversable, the evacuation route attribute for this road segment may be temporarily flagged as being unavailable as an evacuation route or a normally explicated route until the road segment is determined to be traversable. As yet another example, if a particular road segment has an attribute indicating that all northbound and southbound lanes are to be used for northbound traffic during an emergency, the road segment attributes may be updated to include exits along the segment that are accessible to emergency vehicles only.

Any of the attributes (general information or evacuation route) disclosed herein may be defined as bits, characters or strings in the database 62.

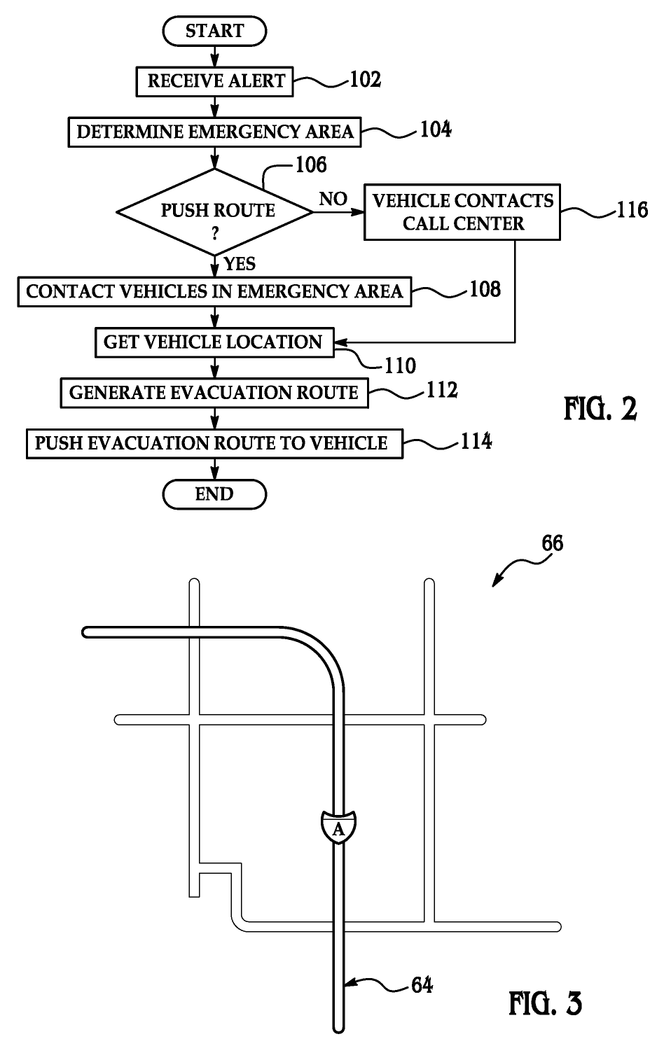

Referring now to FIGS. 2 and 3 together, examples of the method for obtaining evacuation route information are depicted (FIG. 2), and an evacuation route obtained via the method is depicted (FIG. 3). Very generally, the method includes extracting a road segment (having one or more evacuation route attributes associated therewith) from the digital map database 62; and generating an overlay 64 (shown in FIG. 3) of the extracted road segment on a map 66 (shown in FIG. 3) of the emergency region, at least the portion proximate to and including the road segment.

More specifically, and as shown in FIG. 2, an example of the method includes receiving an emergency alert at the call center 46, as shown at reference numeral 102. The alert generally informs the call center 46 of an emergency located within, or potentially threatening an area which the call center 46 services. As a non-limiting example, the alert is generally received from some external source 68 (shown in FIG. 1). The source 68 may be the Internet, radio, television and/or various third-party providers 62 (e.g., traffic centers, weather centers, news feeds, federal agencies, state agencies, local agencies (e.g., city police departments, etc.), or combinations thereof.

The alert may include information regarding the type of emergency, the severity of the emergency, and/or combinations thereof.

Upon receiving and recognizing the alert information, the service advisors 54 input any information regarding the emergency (e.g., type, course/path, speed, etc.) into the network system 56. The inputted information allows the call center 46 to define an emergency area, as shown at reference numeral 104. The emergency area may be defined with latitude and longitude coordinates that bound the area proximate to the emergency. In another example, the emergency area may be bounded by one or more municipalities, counties, and/or states. It is to be understood that the phrase “area proximate to the emergency,” as used herein, refers to the general area surrounding the incident/emergency situation that is affected by, or that may be affected by the incident/emergency situation. For example, the area proximate to a hurricane may include those areas that experience the actual hurricane, high winds, and/or heavy rains. It is to be understood that the area proximate to the emergency may change if the incident changes course/direction or is controlled (e.g., a fire).

Determining the emergency area also includes isolating and extracting one or more road segments from the digital map database 62. The database 62 may be queried for evacuation route attributes that are particular to the emergency (e.g., type, area, etc.). For example, a service advisor 54 may search the database 62 for tornado evacuation routes heading east out of a particular city. Generally, the isolated and extracted road segments have a suitable evacuation route attribute associated therewith. It is to be understood that any road segment that matches the search criteria may be extracted from the database 62.

In one example, multiple contiguous road segments are extracted and connected to form a single evacuation route. It is to be understood that multiple contiguous road segments may transcend state or local boundaries. In another example, multiple road segments are extracted, and some of the segments are connected to form one suitable evacuation route, while others of the segments are connected to form another suitable evacuation route. It is to be understood that a route generator 70 may receive all of the extracted segments and information, and may generate one or more general evacuation routes taking into account the attributes associated with the extracted segments.

In any of the embodiments disclosed herein, it is to be understood that the general evacuation route may be open-ended (i.e., with no specific destination, for example, head north on Highway X), or it may direct numerous vehicles to a particular location (e.g., head north on Highway X toward a designated shelter X).

Once the road segments are extracted and evacuation route(s) is/are generated, an overlay 64 of the evacuation route(s) may be formed on a map 66 of at least a portion of the previously bounded emergency area. It is to be understood that the overlay 64 and map 66 may be displayed at the call center 46, both universally (e.g., on a single projection screen) and locally (e.g., at individual service advisor 54 computers). It is to be understood that the service advisors 54 may toggle the overlay 64 on and off as is desirable at their individual work stations.

The overlay 64 may be colored or patterned or otherwise marked to distinguish it from the remainder of the map 66. The color/pattern/mark may correspond to the type of emergency, the severity level of the emergency, and/or the like, and/or combinations thereof. When multiple evacuation routes are generated, the color/pattern/marks may be used to identify particular routes, and/or to prioritize the routes (e.g., red for a primary route, yellow for a secondary route).

As shown in reference numeral 106, the call center 46 determines whether to push the route(s) to a vehicle 12/vehicle user unsolicited. In an example in which it is decided to push the route unsolicited, generally the service advisor(s) 54 will determine the likelihood that the vehicle 12 is within, traveling toward, or is proximate to the emergency area. As a non-limiting example, the service advisor 54 may query the services database 52 for vehicle “garaged addresses” using the defined emergency area boundary information. It is to be understood that the call center 46 may approximate whether a subscriber's vehicle 12 is in the emergency area by the vehicle's garaged address, which is the residential address of the subscriber. For example, if a subscriber lived in New Orleans during Hurricane Katrina, then the confidence level is high that the subscriber is in or proximate to the emergency area.

Each vehicle 12 (or a user thereof) having a garaged address in or proximate to the emergency area may be contacted by the call center 46, as shown at reference numeral 108. One method of accomplishing this is as follows. Each vehicle identification number (VIN) is known for each subscriber. The VIN may be used to send the previously generated evacuation route(s) to individual vehicles 12. The telematics unit 18 is aware of the VIN of the vehicle 12 in which the unit 18 is installed, and may compare the incoming VIN (from the call center 46) to its own. If the VINs match, then the evacuation route is accepted. In another example, the vehicle 12 may be identified by a STID (Station Identifier) associated with the in-vehicle mobile phone 32. In yet another example, the vehicle 12 may be identified by a MIN (Mobile Identification Number) resident within the telematics unit 18 in-vehicle mobile phone 32.

The call center 46 may also contact the identified vehicles 12 (or user associated therewith) in order to determine the vehicle's (or vehicle user's) actual current position, as shown at reference numeral 110. Upon establishing communication (e.g., via the wireless communication system) with the vehicle 12 or vehicle user, the call center 46 may inquire as to the position of the vehicle 12 and/or user. The call center 46 may communicate directly with the telematics unit 18 and receive the position from the location detection system 24, or the call center may communicate with the vehicle user.

If it is determined that the vehicle 12 and/or vehicle user is located within, traveling toward, or proximate to the emergency area, the previously generated evacuation route may be delivered to the user, or another evacuation route (using the actual position as a starting point) may be generated and delivered, as shown at reference numerals 112 and 114. It is to be understood that both the previously generated route and the specific evacuation route utilizing the actual vehicle/user position include all or some of the extracted road segments.

The evacuation route may be transmitted to the vehicle 12 and/or vehicle user via the service advisor 54. In one example, turn-by-turn navigation instructions are transmitted to the user audibly (e.g., from an automaton) and/or visually (e.g., via a display). In another example, the evacuation route is transmitted to the user via a human advisor speaking the route to the vehicle occupants or user.

In another example, a vehicle user may request an evacuation route, as shown at reference numeral 116. Generally, the user initiates the evacuation route request via the telematics unit 18, and the telematics unit transmits the request from to the call center 46. The user may initiate the evacuation route request via verbal communication, physical communication, and/or combinations thereof. In an example, the operator/user initiates the request via the user interface panel 58.

Physically initiating the request may be accomplished via a button press, touch screen, or the like located in the vehicle 12. It is to be understood that the button press or touch screen is operatively connected to the telematics unit 18. Upon the user's initiation of the button press or touch screen, the telematics unit 18 signals the call center 46 of the fact that the user has initiated a request.

Verbally initiating the request may take place via microphone 28 coupled to the in-vehicle or mobile phone 32 associated with the telematics unit 18. Caller utterances into the microphone 28 are received at a call center 46, which tokenizes the utterance stream for further processing.

Upon initiation of communication between the call center 46 and the vehicle user, the user may inform the call center 46 of his/her current position, or alternately, the vehicle's current position may be transmitted to the call center 46 from the location detection system 24 via the telematics unit 18 (reference numeral 110). Prior to initiating communication, the call center 46 may have already approximated the vehicle's 12 position, for example, via the subscriber's garage address. In this embodiment, the call center 46 may update the position of the vehicle 12 upon establishing communication.

Once the call center 46 obtains the vehicle's then-current position, the call center 46 may identify an evacuation route suitable for the vehicle 12. It is to be understood that the evacuation route may be one or more of the general evacuation route(s) on the overlay 64 that is suitable for the evacuation of numerous vehicles 12 in the area proximate the incident, and/or it may be a more specific route including navigational instructions for the vehicle 12, based, at least in part, on the location of the vehicle 12.

The call center 46 then transmits the route to the vehicle 12 and/or vehicle user using methods previously described.

In any of the methods disclosed herein, it is to be understood that the user's actual position may be used to generate a route that guides a user to an entry point on the general evacuation route.

While several embodiments have been described in detail, it will be apparent to those skilled in the art that the disclosed embodiments may be modified. Therefore, the foregoing description is to be considered exemplary rather than limiting.

1. A method for obtaining evacuation route information, the method comprising:
extracting at least one road segment having an evacuation route attribute associated therewith from a digital map database; and
generating an overlay of the at least one road segment on a map of a predetermined region including the at least one road segment.

2. The method as defined in claim 1 wherein the at least one road segment in the overlay is colored to distinguish it from other data on the map of the predetermined region.

3. The method as defined in claim 2 wherein a color of the at least one road segment corresponds to a predetermined emergency severity level, a predetermined emergency type, or combinations thereof.

4. The method as defined in claim 1, further comprising:
determining an emergency type, an emergency severity level, or combinations thereof;
extracting, based on the determined type, severity level, or combinations thereof, multiple road segments, each of which has an evacuation route attribute associated therewith; and
combining the extracted road segments to form an evacuation route.

5. The method as defined in claim 4 wherein the overlay includes each of the multiple road segments, and wherein each of the multiple road segments is displayed in a predetermined color.

6. The method as defined in claim 5 wherein the predetermined color corresponds to an evacuation route significance level, an emergency type, an emergency severity level, or combinations thereof.

7. The method as defined in claim 1, further comprising removing the overlay from the map.

8. The method as defined in claim 1, further comprising receiving an emergency alert prior to extracting and generating.

9. The method as defined in claim 8, further comprising defining an emergency area based on the emergency alert, and wherein extracting the at least one road segment includes extracting at least one road segment located within the emergency area.

10. The method as defined in claim 1, further comprising delivering the evacuation route information to a vehicle user.

11. The method as defined in claim 10 wherein prior to delivering, the method further comprises receiving a request for evacuation route information from the vehicle user.

12. The method as defined in claim 10 wherein prior to delivering, the method further comprises:
determining if a vehicle is located in an emergency area;
contacting a vehicle that is determined to be located within the emergency area;
determining an actual position of the vehicle that is determined to be located within the emergency area; and
if the actual position of the vehicle is within the emergency area, generating an evacuation route with the vehicle position as a starting point.

13. The method as defined in claim 12 wherein the evacuation route includes the at least one road segment.

14. The method as defined in claim 1, further comprising determining, based on a vehicle user profile, whether the vehicle user should be contacted.

15. The method as defined in claim 14, further comprising:
establishing communication with the vehicle user;
determining if the vehicle user is located within an emergency area;
determining an actual position of the vehicle user; and
if the actual position of the vehicle user is within the emergency area, generating an evacuation route with the actual position as a starting point.

16. The method as defined in claim 1 wherein extracting and generating is accomplished at a call center.

17. A method for delivering evacuation route information to a vehicle user, the method comprising:
receiving an emergency alert at a call center;
defining an emergency area based on the emergency alert;
extracting, from a digital map database, at least one road segment having an evacuation route associated therewith, the at least one road segment being located within the emergency area;
generating an overlay of the at least one road segment on a map of the emergency area;
determining if a vehicle is positioned within the emergency area or is proximate to the emergency area; and
transmitting an evacuation route to the vehicle.

18. The method as defined in claim 17 wherein transmitting the evacuation route is accomplished via a service advisor.

19. The method as defined in claim 17 wherein determining if the vehicle is positioned within the emergency area comprises:
determining a garaged address of the vehicle;
if the garaged address is located within the emergency area, establishing communication with the vehicle;
determining an actual position of the vehicle; and
if the actual position of the vehicle is within the emergency area, generating an evacuation route including the actual position and the at least one road segment.

20. A digital map database, comprising:
a road segment data record containing information associated with a particular road segment; and
at least one evacuation route attribute associated with the road segment, wherein the at least one evacuation route attribute is stored in the road segment data record.

21. The digital map database as defined in claim 20 wherein the at least one emergency route attribute identifies the road segment as part of an evacuation route, identifies traffic flow, traffic direction or traffic volume of the road segment when used as an evacuation route, identifies status of road segment intersections, identifies status of road segment entrances, identifies status of road segment exits, or combinations thereof.

22. The digital map database as defined in claim 20 wherein the at least one emergency route attribute is defined as bits, characters, or strings.
